(19) United States
(12) Patent Application Publication
(10) Pub. No.: US 2004/0252923 A1
(43) Pub. Date: Dec. 16, 2004

(54) Bearing device, and manufacturing method therefor and motor provided with bearing device

(76) Inventors: Yasushi Mizusaki, Suwa-gun (JP); Hisaya Nakagawa, Suwa-gun (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/813,253

(22) Filed: Mar. 30, 2004

(30) Foreign Application Priority Data
Apr. 2, 2003 (JP) 2003-099694

(51) Int. Cl. F16C 33/02

(52) U.S. Cl. 384/279

(57) ABSTRACT

A bearing device includes a bearing member having a bearing surface and a shaft member having a bearing surface which is relatively rotatably supported by the bearing member in such a manner that the bearing surface of the shaft member is arranged so as to face the bearing surface of bearing member. One of the bearing member and the shaft member is formed of a porous metal sintered body having hollow holes and the hollow holes in the bearing surface of the metal sintered body is filled with a lubricating resin to seal apertures in the bearing surface of the hollow holes by the lubricating resin. Thereby the bearing surface is formed of both a resin surface of the lubricating resin and a metal surface of the metal sintered body.

### CROSS REFERENCE TO RELATED APPLICATIONS

This application claims priority to Japanese Application No. 2003-099694 filed Apr. 02, 2003, which is incorporated herein by reference.

### BACKGROUND OF THE INVENTION

1. Field of the Invention

The present invention relates to a bearing device in which a shaft member is relatively and rotatably supported by a bearing member, a manufacturing method for the bearing device, and a motor provided with the bearing device.

2. Description of Related Art

A bearing device in which a shaft member is relatively and rotatably supported by a bearing member is widely used in various types of rotational driving devices such as a motor. In an ordinary bearing device, the bearing surface of a bearing member and the bearing surface of a shaft member are arranged so as to face closely each other in a radial direction or in an axial direction. A surface reforming process such as coating or metal plating is often performed in order to improve the slidability and the abrasion resistance property of the respective bearing surfaces.

For example, in a dynamic pressure bearing device utilizing dynamic pressure of a lubricating fluid such as oil or air, a polyamide-imide film containing PTFE is formed on one of the dynamic pressure bearing surfaces of a shaft member and a bearing member. Further, a surface treatment such as alumite or Ni—P metal plating is performed on the other dynamic pressure bearing surface opposed to the dynamic pressure bearing surface with the polyamide-imide film. After the surface treatments for the bearing surfaces, a lathe machining or the like is performed to attain a dimensional accuracy required for the bearing characteristics or alternatively grooves for generating dynamic pressure are formed by etching process or the like.

However, in the case that the surface reforming process such as coating or metal plating described above is performed, the cost for the bearing device increases. Especially, when coating is performed, much loss of paint occurs and, in addition, coating is repeatedly performed in order to obtain a required coated film thickness with a required dimensional accuracy. Therefore, the surplus of the coated film is cut away by a lathe machining and thus much waste of paint occurs. Moreover, when wet surface treatment such as metal plating is performed, it is difficult to completely eliminate partial defects or partial residual of the process liquid, which may cause rust.

In addition, a lathe machining is used for the shaft member and the bearing member of the bearing device many times, and thus the process cost for the lathe machining increases. Especially, in the case of the dynamic pressure bearing device, the grooves for generating dynamic pressure are formed by the lathe machining or etching processes, and thus further complicated and expensive processes are required.

### SUMMARY OF THE INVENTION

In view of the problems described above, it is an advantage of the present invention to provide a bearing device which is simple with a high degree of accuracy at a low cost, a manufacturing method for the bearing device, and a motor provided with the bearing device.

In order to achieve the above advantage, according to the present invention, there is provided a bearing device including a bearing member having a bearing surface and a shaft member having a bearing surface which is relatively rotatably supported by the bearing member. One of the bearing member and the shaft member is formed of a porous metal sintered body having hollow holes and the hollow holes in the bearing surface of the metal sintered body is filled with a lubricating resin to seal apertures of the hollow holes in the bearing surface by the lubricating resin. Thereby the bearing surface is formed of both the resin surface of the lubricating resin and the metal surface of the metal sintered body.

According to the bearing device having such a constitution, when the sizing step by using a die is applied to the bearing member or the shaft member which is made of the porous metal sintered body, the falling off and the swelling of the resin film due to peeling or the like which occur in the conventional example are prevented. Further, the bearing surface is formed with a high degree of dimensional accuracy without using an expensive lathe machining.

In accordance with an embodiment of the present invention, the bearing device includes dynamic pressure generating grooves for a dynamic pressure bearing device which are formed on the bearing surface comprising both the resin surface of the lubricating resin and the metal surface of the metal sintered body. According to the embodiment of the present invention, the dynamic pressure bearing device which is simple with a high degree of accuracy at a low cost is obtained and thus the usefulness of the dynamic pressure bearing device can be remarkably improved.

In accordance with an embodiment of the present invention, the bearing fluid is air and the lubricating resin is filled to a depth of ten (10) μm or more from the bearing surface. That is, the lubricating resin is preferably filled at least to the depth corresponding to the maximum diameter of the hollow hole (pores). According to the bearing device having such a constitution described above, the aperture of the hollow hole is surely sealed by the lubricating resin and thus the air dynamic pressure bearing device rotated especially at a high speed can easily obtain a satisfactory bearing characteristic. Therefore, the dynamic pressure bearing device which is simple with a high degree of accuracy at a low cost is obtained and thus the usefulness of the dynamic pressure bearing device can be remarkably improved.

In accordance with an embodiment of the present invention, the lubricating resin is preferably filled by impregnation and thus the filling operation of the lubricating resin can be easily performed and the productivity of the bearing device can be improved.

The above-mentioned bearing device according to the present invention is preferably applied to a motor to obtain a satisfactory rotational characteristic easily and the performance of the motor can be improved at a low cost.

In addition, in order to achieve the above advantage, according to the present invention, there is provided a manufacturing method for a bearing device including providing a blank material which is formed of a porous metal sintered body having hollow holes for a bearing member including a bearing surface, coating a lubricating resin on the bearing surface of the metal sintered body, after the coating, impregnating the lubricating resin on the bearing surface of the metal sintered body to seal the apertures of the hollow holes in the bearing surface of the metal sintered body, and then, removing a surplus lubricating resin from a surface of a metal which forms the bearing surface of the bearing member, forming the bearing surface comprised of both the surface of the lubricating resin and the surface of the metal of the metal sintered body, and arranging the bearing surface of bearing member so as to face a bearing surface of a shaft member which is relatively rotatably supported by the bearing member.

According to the manufacturing method for a bearing device having steps described above, when the sizing step by using a die is applied to the bearing member which is made of the porous metal sintered body, the falling off and the swelling due to the peeling or the like of the resin film which occur in the conventional example are prevented. Further, the bearing surface is formed with a high degree of dimensional accuracy without using an expensive lathe machining.

Further, in accordance with an embodiment of the present invention, the lubricating resin is preferably not impregnated in a depth at least 10 μm or more from the outer peripheral wall surface of the bearing member on a center side. According to the manufacturing method for a bearing device described above, the lubricating resin does not surely seep out from the outer peripheral wall surface of the bearing member.

Other features and advantages of the invention will be apparent from the following detailed description, taken in conjunction with the accompanying drawings that illustrate, by way of example, various features of embodiments of the invention.

### BRIEF DESCRIPTION OF DRAWINGS

FIG. 1 is an explanatory longitudinal cross sectional view which shows a polygonal mirror driving motor for an optical deflection device in accordance with an embodiment of the present invention.

FIG. 2 is an explanatory enlarged view showing the bearing surface on the inner peripheral side of a bearing sleeve which is used in the motor shown in FIG. 1.

FIG. 3 is an explanatory enlarged longitudinal cross sectional view which shows the bearing surface portion on the inner peripheral side of the bearing sleeve used in the motor shown in FIG. 1.

FIG. 4 is a graph which shows the measured results of the bearing abrasion when the air dynamic pressure bearing device is mounted on the motor and the sliding accelerated test is performed.

FIG. 5 is a graph which shows the occurred results of the motor defective stopping when the air dynamic pressure bearing device is mounted on the motor and the sliding accelerated test is performed.

### DETAILED DESCRIPTION OF THE PREFERRED EMBODIMENTS

An embodiment of the present invention will be described in detail below with reference to the accompanying drawings. First, a constitutional example of a polygonal mirror driving motor in an optical deflection device to which the present invention is applied will be described.

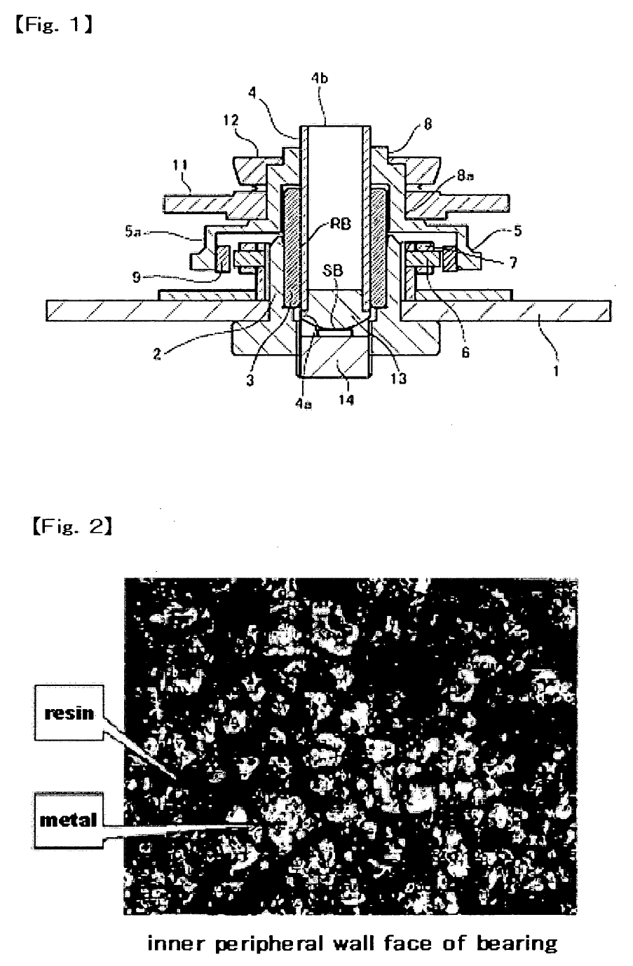

As shown in FIG. 1, a bearing holder 2 formed in a roughly hollow cylindrical shape is mounted and erected on an approximately center portion of a motor base plate 1 which is also used as a circuit board. A bearing sleeve 3 as a fixed bearing member which utilizes air dynamic-pressure is joined on the inner peripheral wall face side of the bearing holder 2 by adhesion, lightly press-fitting, shrinkage fitting or the like. The bearing sleeve 3 is a hollow cylindrical shaped member which is made of copper based metal material such as phosphor bronze to easily perform machining a hole having a small diameter and its detailed constitution is described below.

A rotation shaft 4 constituting a rotor part is rotatably inserted in a center hole provided in the bearing sleeve 3. The rotation shaft 4 is formed by using a stainless steel member in a substantially tubular shape, which is made of a hollow cylinder pipe. The rotation shaft 4 is provided with opening parts 4a and 4b at both lower and upper end portions in the axial direction in the drawing. The lower end face of the rotation shaft 4, i.e., the annular end face which forms the opening part 4a is arranged so as to be extended to a position protruding in the axial direction outward (downward direction in the drawing) from the bearing surface of the above-mentioned radial bearing part RB. Therefore, the lower end portion in the drawing of the rotation shaft 4 does not position at the bearing surface portion of the radial bearing part RB.

A sealing cap member 13 is fitted into the opening part 4a of the rotation shaft 4 so as to close the opening part 4a. The sealing cap member 13 is formed to protrude from the opening part 4a of the rotation shaft 4 toward downward side in the drawing in such a manner that its downward surface is formed in an approximately hemispheric shape. The downward top part of the approximately hemispheric surface of the sealing cap member 13 abuts with a disk-shaped thrust plate 14 to constitute a thrust bearing part SB in a pivot shape, i.e., in a point-contacted manner. The thrust plate 14 is attached to the bearing holder 2 so as to close an opening part provided on a lower end side of the bearing holder 2.

The dynamic pressure surface formed on the inner peripheral wall part of the bearing sleeve 3 is disposed so as to face the dynamic pressure surface formed on the outer wall surface of the rotation shaft 4 via a minute gap space in the radial direction. The radial dynamic pressure bearing part RB is constituted of the dynamic pressure surface of the bearing sleeve 3 and the dynamic pressure surface of the rotation shaft 4 via the minute gap space. In other words, the dynamic pressure surface of the bearing sleeve 3 and the dynamic pressure surface of the rotation shaft 4 in the radial dynamic pressure bearing part RB are arranged so as to circumferentially face each other via the minuscule gap space of several μm width. Air as a lubricating fluid is filled and present in the bearing space formed by the minuscule gap space.

Radial dynamic pressure generating grooves having an appropriate groove configuration are annularly formed on at least one of both the dynamic pressure surfaces of the bearing sleeve 3 and the rotation shaft 4 in a concaved and parallel manner in the peripheral direction. Air as the lubricating fluid is pressurized and a dynamic pressure is generated by the pumping operation of the radial dynamic pressure generating grooves during rotation. A rotor case 5 described below along with the rotation shaft 4 is supported in a non-contact manner in the radial direction to the bearing sleeve 3 by means of the dynamic pressure of the air as the lubricating fluid.

At a portion of the bearing holder 2 protruded upward from the motor base plate 1 in the drawing, a stator core 6 which is a laminated body formed of electromagnetic steel plates is fitted to a mounting face on an outer peripheral side of the bearing holder 2 in an axial direction. Coil windings 7 are respectively wound around each of a plurality of salient pole parts which are provided in the stator core 6 so as to protrude outward in the radial direction.

A stepped cylindrical rotor boss 8 formed of aluminum alloy is fixed to the rotation shaft 4 through a tight-fitting process such as press fitting, shrinkage fitting or the like on the output portion of the rotation shaft 4 protruded upward from the bearing sleeve 3. A center portion of the rotor case 5 formed in an approximately dish-like configuration is adjacently joined to the rotor boss 8 in an integral manner or by caulking or the like on the lower side of the rotor boss 8 in the drawing.

A ring-shaped rotor magnet 9 is mounted on the inner peripheral wall face of an outside wall part 5a which is provided in an outer peripheral side portion of the rotor case 5. The inner peripheral wall face of the rotor magnet 9 is arranged so as to closely face the outer end face of the respective salient pole parts of the stator core 6 in the radial direction.

A mounting part 8a is formed in a stepped shape on an outer peripheral portion of the rotor boss 8. A polygonal mirror 11 for performing the deflection scanning of the optical information is fitted on the stepped part of the mounting part 8a. The polygonal mirror 11 is fixed such that the mirror 11 is pushed and held in the axial direction by a dish-like pressure member 12 which is attached on the upper end portion side of the rotation shaft 4 by fixing screws or the like not shown in the drawing.

The bearing sleeve 3 is formed through a powder metallurgy process by using a metal sintered body such as porous phosphor bronze which is provided with a large number of hollow holes (pores). More concretely, lubricating resin containing fluorine resin is coated on the inner peripheral wall face of a blank material of the bearing sleeve 3 which is formed by hardening the metal powder. In other words, a lubricating resin comprising polyamide-imide containing PTFE (polytetrafluoroethylene) at an appropriate ratio is coated on the inner peripheral wall face of the bearing sleeve 3 and, immediately after the coating is performed, a negative pressure is applied to the blank material of the bearing sleeve 3 from the outer wall face side of the bearing sleeve 3 by a vacuum pump. Therefore, the lubricating resin (coating material) adhered on the inner peripheral wall face of the blank material of the bearing sleeve 3 is impregnated and filled into the hollow holes (pores) of the metal sintered body by means of the suction by the vacuum pump and the sealing of the pores is performed.

The suction time period and the sucking force by the vacuum pump are adjusted such that the impregnation of the lubricating resin (coating material) is performed to have a depth of ten (10) μm or more from the inner peripheral wall face of the blank material of the bearing sleeve 3.

Further, in the case that the outer wall face of the bearing sleeve 3 is adhesively bonded on the inner peripheral wall face of the bearing holder 2, the impregnation of the lubricating resin (coating material) is performed so as not to reach within the depth range of ten (10) μm from the outer wall face of the blank material of the bearing sleeve 3. In other words, the lubricating resin is not impregnated in a depth at least 10 μm or more in the radial direction from the outer peripheral wall surface of the bearing member. According to the constitution described above, the PTFE contained in the lubricating resin (polytetrafluoroethylene) does not affect the adhesive fixing between the bearing sleeve 3 and the bearing holder 2.

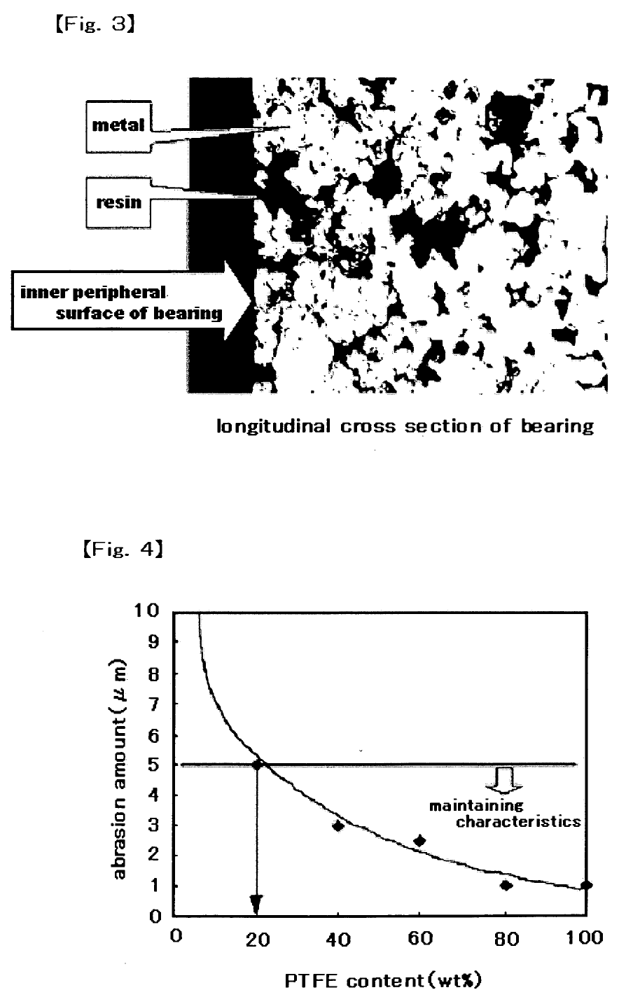

Moreover, the surplus lubricating resin (coating material), which is remained on the inner peripheral wall face of the blank material of the bearing sleeve 3 after the impregnation of the lubricating resin, is removed by brushing or the like before the surplus lubricating resin is cured. Therefore, the impregnated resin and the metal form the bearing surface. In other words, the inner peripheral wall surface of the blank material of the bearing sleeve 3 is constituted, for example, as shown in FIGS. 2 and 3, such that the metal sintered body and the lubricating resin are exposed on the surface at random. The lubricating resin does not cover the surface of the metal in the bearing surface of the metal sintered body and does not also protrude from the surface of the metal surrounding the aperture of the hollow hole (pores) formed in the bearing surface of the metal sintered body.

In general, the ratio of the hollow holes (pores) to the metal of the metal sintered body is roughly between 30% and 70%, and generally between 40% and 60%. Therefore, the ratio of the lubricating resin with respect to the metal in the bearing surface becomes roughly between 30% and 70%, and generally between 40% and 60%. Further, since the position and size of the hollow holes (porous) are random, the bearing surface is formed by the metal and the lubricating resin at random.

Next, the blank material of the bearing sleeve 3 is heated at about 100° C. to perform the volatilization of solvent. Further, after then, the blank material of the bearing sleeve 3 is heated so as to increase the temperature up to about 230° C. to perform the curing of the lubricating resin (coating material). Next, a pressing step with the use of a die on which dynamic-pressure generating grooves are formed beforehand, i.e., a die sizing step is performed on the inner peripheral wall surface of the blank material of the bearing sleeve 3 in which the lubricating resin is cured. Thereby the transfer of the dynamic-pressure generating grooves is performed and the finished product of the bearing sleeve 3 is obtained. At this time, the metal of the sintered body and the cured lubricating resin are processed so as to be crushed in the axial direction and the radial direction in the die sizing step. Therefore, the metal of the sintered body and the lubricating resin entered into the hollow holes (porous) are joined firmly.

An anaerobic adhesive is coated on the outer peripheral wall surface of the bearing sleeve 3 which is obtained as described above, and then the bearing sleeve 3 is inserted on the inner peripheral wall surface of the bearing holder 2 and the outer peripheral wall surface of the bearing sleeve 3 is fixed, for example, with an adhesive. In the case that the bearing sleeve 3 is fixed with an adhesive, the bearing sleeve 3 is inserted with respect to the inner peripheral wall surface of the bearing holder 2 by clearance fitting such that the distortion of the bearing sleeve 3 does not occur.

The bearing holder assembly provided in this way is fixed to the above-mentioned motor base plate 1 by caulking or the like.

According to the present embodiment having such a constitution, even when the die sizing step is performed on the bearing sleeve 3 which is made of porous metal sintered body as the bearing member, the falling off and the swelling due to the peeling or the like of the resin film which occur in the conventional example are prevented. Furthermore, the bearing surface is formed with a high degree of dimensional accuracy without using an expensive lathe machining.

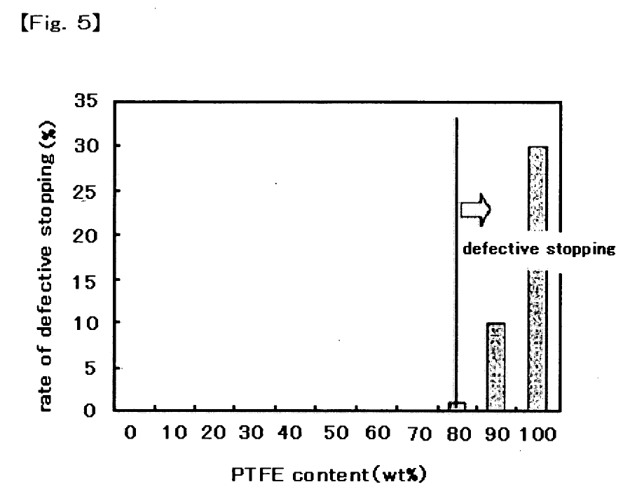

FIGS. 4 and 5 show the measured results when the air dynamic-pressure bearing device in the above-mentioned embodiment is mounted on a motor and a sliding acceleration test is performed. More concretely, in the air dynamic-pressure bearing device, polyamide-imide group lubricating resin with the content of PTFE (polytetrafluoroethylene) is changed is impregnated in the dynamic-pressure bearing surface of the bearing sleeve 3 and the rotation shaft 4 is made of stainless steel SUS 303.

FIG. 4 shows that the PTFE has a high lubricating ability because the bearing abrasion amount (vertical axis) decreases largely as the content of the PTFE (horizontal axis) increases. When the bearing abrasion amount for maintaining various characteristics of a motor, for example, the maximum abrasion amount (one side) required to maintain the plane tilt characteristic of the polygon mirror 11 in the embodiment described above is set to be 5 μm, the content of the PTFE is preferable to be 20% or more by weight.

On the other hand, the PTFE easily causes aggregation when the PTFE becomes abrasion powder and thus it is hard to be discharged outside the bearing. Therefore, as the content of the PTFE increases too much higher, the aggregated object is accumulated to cause the bearing gap space to be narrower. This may cause the rotation shaft 4 to be unable to keep rotating and bring a defective stopping state of the motor as shown in the right side range of FIG. 5. In order to prevent such a motor defective stopping due to the clogging of the abrasion powder, judging from the results shown in FIG. 5, it is preferable to set the content of the PTFE at 70 wt % or less.

In a motor provided with the dynamic pressure bearing device in the above-mentioned embodiment of the present invention, a higher degree of dimensional accuracy is required than in a motor provided with an ordinary bearing device. According to the embodiment of the present invention, the dimensional accuracy required in such a dynamic pressure bearing device can be easily obtained.

Especially, in the above-mentioned embodiment of the present invention, air is used as the bearing fluid in the dynamic pressure bearing device for a high speed rotation. Further, the lubricating resin used in the dynamic pressure bearing device is filled from the bearing surface to the depth of 10 (ten) μm or more. Therefore, the lubricating resin is filled at least to the depth corresponding to the maximum diameter of the hollow hole or the pores and thus the aperture of the hollow hole (pores) in the bearing surface is surely sealed and the necessary bearing characteristic of the motor is easily obtained.

The embodiment of the present invention is concretely described above. However, needless to say, the present invention is not limited to the embodiment described above, and many modifications can be made without departing from the subject matter of the present invention.

For example, in the above-mentioned embodiment, the present invention is applied to the fixed bearing member (bearing sleeve). However, the present invention is similarly applied to a rotation member, i.e., the shaft member as well as the fixed member.

Further, in the above-mentioned embodiment of the present invention, the PTFE is added in the lubricating resin. However, other fluorine resin such as PFA, FEP and ETFE is applicable and solid lubricant such as molybdenum disulfide, graphite and tungsten disulfide may be added thereto.

In the above-mentioned embodiment of the present invention, the dynamic pressure generating grooves are formed by the die sizing step but may be formed by form rolling or cutting.

In addition, in the above-mentioned embodiment of the present invention, the present invention is applied to the motor provided with the dynamic pressure bearing device. However, the present invention may be similarly applied to an ordinary bearing device and, furthermore, to a motor other than the polygonal mirror driving motor or other various rotational driving devices.

As described above, the bearing device according to the present invention is constituted in such a manner that one of the bearing member and the shaft member is formed of a porous metal sintered body having hollow holes and the hollow holes in the bearing surface of the metal sintered body is filled with a lubricating resin to seal apertures in the bearing surface of the hollow holes by the lubricating resin. Therefore, the bearing surface is formed of both a resin surface of the lubricating resin and a metal surface of the metal sintered body.

Consequently, according to the bearing device having such a constitution, when the sizing step by using a die is applied to the bearing member or the shaft member which is made of the porous metal sintered body, the falling off and the swelling due to the peeling or the like of the resin film are prevented and the bearing surface is formed with a high degree of dimensional accuracy without using an expensive lathe machining.

Further, the manufacturing method for a bearing device according to the present invention includes providing a blank material which is formed of a porous metal sintered body having hollow holes for a bearing member including a bearing surface, coating a lubricating resin on the bearing surface of the metal sintered body, after the coating, impregnating the lubricating resin on the bearing surface of the metal sintered body to seal apertures of the hollow holes in the bearing surface of the metal sintered body, and then, removing a surplus lubricating resin from a surface of a metal which forms the bearing surface of the bearing member, forming the bearing surface comprised of both the surface of the lubricating resin and the surface of the metal of the metal sintered body.

According to the manufacturing method for a bearing device described above, when the sizing step by using a die is applied to the bearing member which is made of the porous metal sintered body, the falling off and the swelling due to the peeling or the like of the resin film which occur in the conventional example are prevented. Further, the bearing surface is formed with a high degree of dimensional accuracy without using an expensive lathe machining.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A bearing device comprising:
a bearing member including a bearing surface; and
a shaft member including a bearing surface which is relatively rotatably supported by the bearing member in such a manner that the bearing surface of the shaft member is arranged so as to face the bearing surface of bearing member;
wherein one of the bearing member and the shaft member is formed of a porous metal sintered body having hollow holes and the hollow holes in the bearing surface of the metal sintered body is filled with a lubricating resin to seal apertures in the bearing surface of the hollow holes by the lubricating resin and thereby the bearing surface is formed of both a resin surface of the lubricating resin and a metal surface of the metal sintered body.

2. The bearing device according to claim 1, further comprising dynamic pressure generating grooves for a dynamic pressure bearing device which are formed on the bearing surface comprising both the resin surface of the lubricating resin and the metal surface of the metal sintered body.

3. The bearing device according to claim 2, wherein the bearing fluid is air and the lubricating resin is filled to a depth of ten (10) μm or more from the bearing surface.

4. The bearing device according to claim 1, the lubricating resin is filled by impregnation.

5. A motor provided with a bearing device, the bearing device comprising:
a bearing member including a bearing surface; and
a shaft member including a bearing surface which is relatively rotatably supported by the bearing member in such a manner that the bearing surface of the shaft member is arranged so as to face the bearing surface of bearing member;
wherein one of the bearing member and the shaft member is formed of a porous metal sintered body having hollow holes and the hollow holes in the bearing surface of the metal sintered body is filled with a lubricating resin to seal apertures in the bearing surface of the hollow holes by the lubricating resin and thereby the bearing surface is formed of both a resin surface of the lubricating resin and a metal surface of the metal sintered body.

6. A manufacturing method for a bearing device comprising:
providing a blank material which is formed of a porous metal sintered body having hollow holes for a bearing member including a bearing surface;
coating a lubricating resin on the bearing surface of the metal sintered body;
after the coating, impregnating the lubricating resin on the bearing surface of the metal sintered body to seal apertures of the hollow holes in the bearing surface of the metal sintered body;
and then, removing a surplus lubricating resin from a surface of a metal which forms the bearing surface of the bearing member;
forming the bearing surface comprised of both the surface of the lubricating resin and the surface of the metal of the metal sintered body; and
arranging the bearing surface of bearing member so as to face a bearing surface of a shaft member which is relatively rotatably supported by the bearing member.

7. The manufacturing method for a bearing device according to claim 6, wherein the lubricating resin is not impregnated in a depth at least 10 μm or more from an outer peripheral wall surface of the bearing member on a center side.

8. A bearing device comprising:
a bearing member having a bearing surface; and
a shaft member having a bearing surface and being rotatably coupled to the bearing member such that the bearing surface of the shaft member faces the bearing surface of the bearing member;
wherein one of the bearing member and the shaft member includes a porous metal sintered body having hollow holes and the hollow holes contain a lubricating resin to seal apertures in the bearing surface of the hollow holes such that the bearing surface of the one member includes both a resin surface of the lubricating resin and a metal surface of the metal sintered body.

9. The bearing device according to claim 8, wherein the bearing device is a dynamic pressure bearing device having dynamic pressure generating grooves formed on the bearing surface having both the resin surface of the lubricating resin and the metal surface of the metal sintered body.

10. The bearing device according to claim 9, wherein the bearing fluid is air and the lubricating resin is filled to a depth of ten (10) μm or more from the bearing surface of the one member.
